(19) United States
(12) Patent Application Publication
(10) Pub. No.: US 2008/0243416 A1
(43) Pub. Date: Oct. 2, 2008

(54) GLOBAL CALIBRATION FOR STEREO VISION PROBE

(75) Inventor: Robert Kamil Bryll, Bothell, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: MITUTOYO CORPORATION, Kawasaki-shi (JP)

(21) Appl. No.: 11/694,837

(22) Filed: Mar. 30, 2007

(51) Int. Cl. G06F 19/00

(52) U.S. Cl. 702/95; 250/252.1; 73/1.79

(57) ABSTRACT

A method for global calibration of a multi-view vision-based touch probe measurement system is provided which encompasses calibrating camera frame distortion errors as well as probe form errors. The only required features in the calibration images are the markers on the touch probe. The camera frame distortion calibration comprises an iterative process that depends on a portable calibration jig and the touch probe, but that process is unaffected by probe form distortion errors in the touch probe and/or tip. The probe tip position calibration depends on applying the results of the camera frame distortion calibration. When the same probe tip is used throughout the global calibration, the probe tip position calibration uses images from the set of images used by the camera frame distortion calibration. The global calibration method is particularly advantageous for low cost portable versions of multi-view vision-based touch probe measurement systems.

### FIELD OF THE INVENTION

The invention relates generally to precision measurement instruments, and more particularly to a system and method of global calibration for a multi-view vision-based touch probe locating system that is used in a coordinate measuring system.

### BACKGROUND OF THE INVENTION

Various types of touch probe coordinate measuring systems are known. In the type of touch probe coordinate measuring system under consideration here, the workpiece is measured by using a multi-camera vision system to determine the location of the touch probe when the touch probe tip is at a desired location on a workpiece surface. A visual marker pattern is located on the body of the touch probe, with the markers being imaged by at least two cameras of the vision system, and the images are used to triangulate the position of each of the markers in three dimensional space. Based on this data the probe tip location coordinates and the adjacent workpiece surface coordinates may be inferred or estimated.

Factors that limit the measurement accuracy of the type of touch probe measurement systems outlined above include errors that are introduced by distortions and/or erroneous assumptions regarding the coordinate frame associated with the multi-camera vision system. Such errors are referred to as camera frame distortion errors herein. Errors are also introduced by distortions and/or erroneous assumptions regarding the relationship between the marker locations in the probe tip location. Such errors are referred to as probe form errors herein.

U.S. Pat. Nos. 5,828,770, 5,805,287, and 6,497,134 each disclose various features related to the type of touch probe coordinate measuring system outlined above, and each is hereby incorporated by reference in its entirety. The '770 patent describes systems and methods related to performing measurements using an object (e.g. a probe) that includes a plurality of activatable markers. However, the '770 patent is generally not directed toward systems and methods for reducing camera frame distortion errors or probe form errors, and includes few, if any, teachings in this regard.

In contrast, the '287 patent discloses a method for calibrating and/or correcting certain types of camera frame distortion errors. To briefly summarize that calibration method, the '287 patent teaches that: (i) the positions of permanently mounted light sources or reflectors are registered by their image on each camera, and their positions in the image are given as coordinates related to a camera fixed coordinate system; and (ii) the positions of at least two points for which the mutual separation distances are known are registered by holding a probing tool in contact with the points, and the positions of the points are calculated from the observed images of the light sources or reflectors of the probing tool. Based on the obtained data, the correct length scale in the camera frame may be established, and optical properties of the cameras may be mathematically modeled such that image distortions occurring through the camera lens may be compensated, all of which falls within the scope of calibrating and/or compensating camera frame distortion errors. However, the teachings of the '287 patent with regard to camera frame distortion errors do not encompass potential probe form errors, or their potential deleterious influence on the camera frame distortion calibration methods of the '287 patent.

The '134 patent discloses a method for calibrating and/or correcting a probe form error. In particular, the '134 patent addresses determining a location error for a feature of a surgical probe or instrument (e.g. its tip), relative to a set of energy emitters (e.g. markers) on its body. To briefly summarize the calibration method, the '134 patent teaches that the location error is found by: (i) calculating the position and orientation of the body having the energy emitters disposed thereon, in a plurality of orientations and positions relative to a reference frame, but with the feature (e.g. the tip) in a substantially constant position relative to the reference frame, (ii) calculating the locations of the feature of the object (e.g. the tip) from these calculated positions and orientations, (iii) averaging these calculated locations, (iv) determining the location of the feature by physical measurement thereof in relation to the physical locations of the emitters, and (v) comparing the calculated average location with the physically measured location to arrive at the error. In order to reduce or avoid the effects of camera frame distortion errors when determining probe form error, the teachings of the '134 patent include imaging a local reference frame that comprises an additional plurality of “fixed emitters”, at the same time that the “body emitters” are imaged. Calculating the positions and orientations of the “body emitters” relative to the additional “fixed emitters”, rather than relative to the overall camera frame, largely circumvents the effects of camera frame distortion errors. Otherwise, the teachings of the '134 patent with regard to calibrating or correcting probe form error do not encompass potential camera frame distortion errors, or their potential deleterious influence on probe form error calibration methods in the absence of additional “fixed emitters” in the calibration images.

As outlined above, a calibration method that efficiently encompasses camera frame distortion errors, as well as probe form errors, is not in evidence. Rather, separate calibration of these errors, using fixed reference emitters, or the like, is the norm. The present invention is directed to providing a system and method that overcomes the foregoing and other disadvantages.

### SUMMARY OF THE INVENTION

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In general, the invention disclosed herein is described in terms of its application to a system that uses dual-camera stereo vision. However, it should be appreciated that the invention disclosed herein is applicable to any system configuration that can be used to provide a valid set of triangulation images (e.g. at least two respective images of the same object taken from at least two respective viewpoints, using stable triangulation geometry). For example, the invention may be readily adapted to sets of triangulation images that are provided from at least two controlled or known viewpoints using a single camera, or to sets of more than two triangulations images (e.g. provided from three cameras at three viewpoints). In general, in many or most contexts herein, the term camera may be generalized to the term view or viewpoint. For example, a multi-camera triangulation system is one instance of the more general case, which is a multi-viewpoint triangulation system. Thus, the various embodiments described herein are exemplary only, and not limiting.

A system and method for efficient global calibration of a multi-view vision-based touch probe locating system is provided which encompasses determining camera frame distortion errors as well as probe form errors wherein the only relevant features in the calibration images comprise the markers or emitters on the touch probe. The camera frame distortion calibration operations comprise an iterative calibration process that depends on the use of a touch probe with a tip. Nevertheless, the camera frame distortion calibration operations are independent of, or unaffected by, any probe form distortion errors in the touch probe and/or tip. The probe tip position calibration operations depend on the results of the camera frame distortion calibration, and also use calibration images wherein the only relevant features in the images are the markers on the touch probe. When the same probe tip is used throughout the entire global calibration procedure, particular efficiency results from the fact that the images used by the probe tip position calibration operations are from the same set of images used by the camera frame distortion calibration operations. It should be appreciated that the term “camera frame distortion” as used herein refers to a coordinate system frame, not a physical frame.

The global calibration method is particularly advantageous for a practical and low cost portable and/or “desktop” version of a multi-camera vision-based touch probe locating system, although its use is not restricted to such systems. It should be appreciated that the features of prior art systems, such as separate calibration procedures for various types of errors and/or the use of fixed marker arrangements in addition to the markers included on the probe body, may make the cost and/or complexity of such systems prohibitive for many applications. It should be appreciated that for “desktop” systems, ease-of-use is a critical factor, in that such systems may be intended for use by relatively unskilled or occasional users that demand the best possible calibration results while using the simplest possible calibration objects and the simplest and most comprehensible set of operations. It should also be appreciated that “desktop” systems may be constructed using low cost materials and techniques, such that interchangeable parts such as probe styli or tips are formed imprecisely and/or cameras and/or mechanical frames may be relatively more susceptible to thermal or physical distortions, or the like. Thus, for desktop systems, simple and efficient calibration may assume relatively more importance than it has in prior art systems, such as industrial and medical systems.

In accordance with another aspect of the invention, the global calibration system includes a probe, a multi-view triangulation system, and a portable calibration jig. The probe may be a manual touch probe which includes a marker pattern with a plurality of markers (e.g. IR LEDs) on the probe body. The multi-view triangulation system is operable to determine first-level three dimensional coordinates for each of the probe markers based on images from at least two respective views. The portable calibration jig may include a plurality of probe tip positioning reference features (e.g. visual fiducials or mechanical constraints). In one embodiment, during the calibration process, the probe tip is constrained at each of the reference features of the portable calibration jig, while the body of the probe is rotated around the tip and the multi-view triangulation system takes images of the probe markers. Through triangulation of the positions of the probe markers, their three dimensional coordinates may be determined. The locations of the probe markers in the various orientations may be analyzed to estimate the coordinates of the location of the probe tip and the reference feature that it is constrained at. The geometric relationships between the estimated/measured locations of the reference features may be compared with known geometric relationships between the reference features, in order to provide a camera frame distortion calibration (e.g. a set of coordinate frame distortion parameters that characterize and/or compensate for errors related to camera distortion and/or camera position errors) that approximately eliminates the camera frame distortion errors. An iterative procedure may improve the accuracy of the estimated/measured locations of the reference features and the camera frame distortion calibration. In various embodiments, the locations of the probe markers in the various orientations may also be corrected using the camera frame distortion calibration, and then analyzed to define a local coordinate system (LCS) relative to the touch probe marker pattern. In various embodiments, principal component analysis (PCA), or the like, may be used to determine the LCS. For each orientation, a probe tip position vector may then be defined between a reference point in the corresponding LCS and the best available estimated coordinates of the corresponding reference feature. The probe tip position vectors corresponding to each orientation may then be averaged, or fit using least squares fit, or otherwise analyzed, to determine the probe tip position calibration.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a diagram of a first exemplary embodiment of a stereo vision touch probe system calibration arrangement;

FIG. 2 is a diagram illustrating various features of a touch probe, including imperfections which may be addressed by probe tip position calibration;

FIG. 3 is a schematic diagram illustrating various aspects of a global calibration process according to this invention, wherein the tip of a touch probe is constrained at a reference feature while the body of the probe with markers is rotated so that marker measurement images may be taken with the touch probe in multiple orientations; and

FIGS. 4A-4C are flow diagrams illustrating one exemplary routine according to this invention for global calibration of a multi-view vision-based touch probe system.

### DETAILED DESCRIPTION OF THE PREFERRED EMBODIMENT

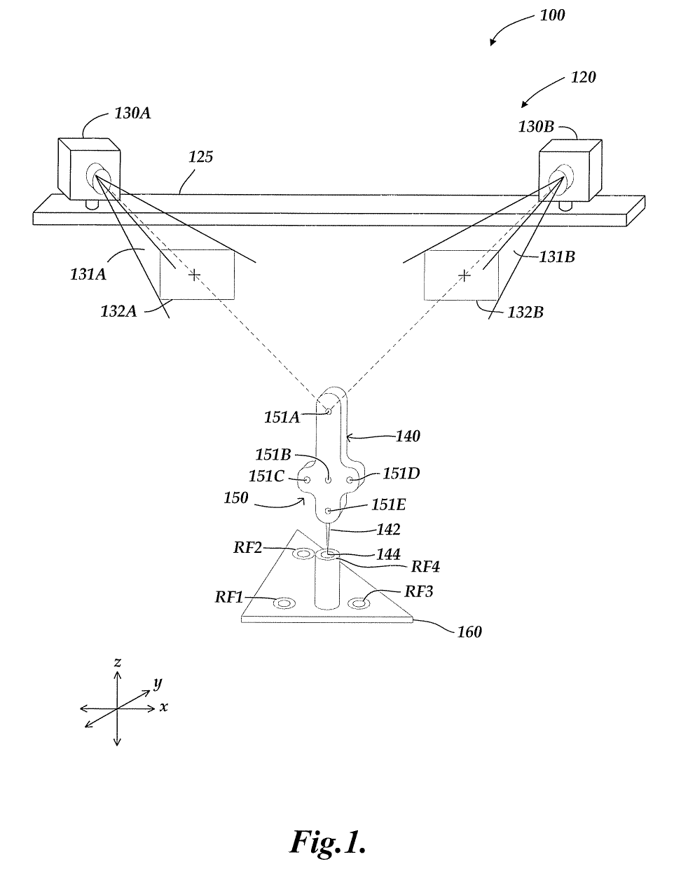

FIG. 1 is a diagram of a first exemplary embodiment of a multi-view touch probe system calibration arrangement 100. The present arrangement may be interchangeably referred to as a stereo-vision touch probe system calibration arrangement 100, since this particular embodiment uses a typical dual-camera stereo vision arrangement. The calibration arrangement 100 includes a stereo vision touch probe system 120 and a portable calibration jig 160. The stereo vision touch probe system 120 includes a mounting frame 125, two cameras 130A and 130B, and a touch probe 140. The body of the touch probe 140 includes a marker pattern 150, which includes a set of individual markers 151A-151E that are imaged by the stereo vision cameras 130A and 130B. Each of the individual markers 151A-151E may comprise IR LEDs or other light sources or any other types of markers which may be reliably imaged by the stereo vision cameras. The end of the touch probe 140 also includes a stylus 142 with a probe tip 144. The stylus 142 and/or the probe tip 144 may be interchangeable or replaceable on the touch probe 140. In various embodiments, similar to the majority of touch probes used in automated coordinate measurement machines, the touch probe 140 may be of a type that emits a data capture trigger signal when the probe tip 144 is deflected (e.g. by a sub-micron increment) relative to its nominal position. However, in various other embodiments, and particularly in manual touch probe systems, the stylus 142 and/or the probe tip 144 may be rigidly attached to the body of the touch probe 140 and a data capture trigger signal may be provided by other means, e.g. by the user activating a mouse or keyboard button or other switch.

In operation, the stereo vision cameras 130A and 130B are able to image the locations of the markers 151A-151E, which are rigidly located relative to one another and relative to the location of the probe tip 144. The stereo vision cameras 130A and 130B have imaging volumes 131A and 131B and fields of view 132A and 132B, respectively, for viewing the markers 151A-151E. The imaging volumes 131A and 131B intersect to define an approximate working volume of the stereo vision touch probe system 120. In the illustration of FIG. 1, a “crosshair” marker is shown where the probe marker 151A would appear in the images of the fields of view 132A and 132B. Generally speaking, known geometric triangulation methods may be used to determine the coordinates of the markers in the working volume based on their locations in the images, in combination with known positions and orientations of the cameras. It will be appreciated that the accuracy of such triangulation methods may be compromised by camera frame distortion errors (e.g. errors due to optical distortions, as well as due to distortions of the presumed relationship between the camera positions and orientations), as previously discussed.

As will be described in more detail below, global calibration of the stereo vision touch probe system 120 is performed using a calibration jig such as the portable calibration jig 160, which supports calibration of both camera frame distortion errors and probe form errors. The portable calibration jig 160 includes four reference features RF1-RF4. The distance relationships between the reference features RF1-RF4 are known, and the probe tip 144 can be placed at each reference position and constrained against translational motion while the body of the probe 140 is rotated around the constrained position of the probe tip 144. In one embodiment, each of the reference features RF1-RF4 includes a mechanical constraint, e.g. a conical recess or other kinematic constraint, to assist in preventing translation of the probe tip 144 while the body of the probe 140 is rotated around it. In another embodiment, a sharp probe tip is used, and the reference features are marked with a fiducial, or the like. The user then positions and constrains the sharp probe tip manually at the constraint position indicated by the fiducial, prior to rotating the body of the probe 140 around it.

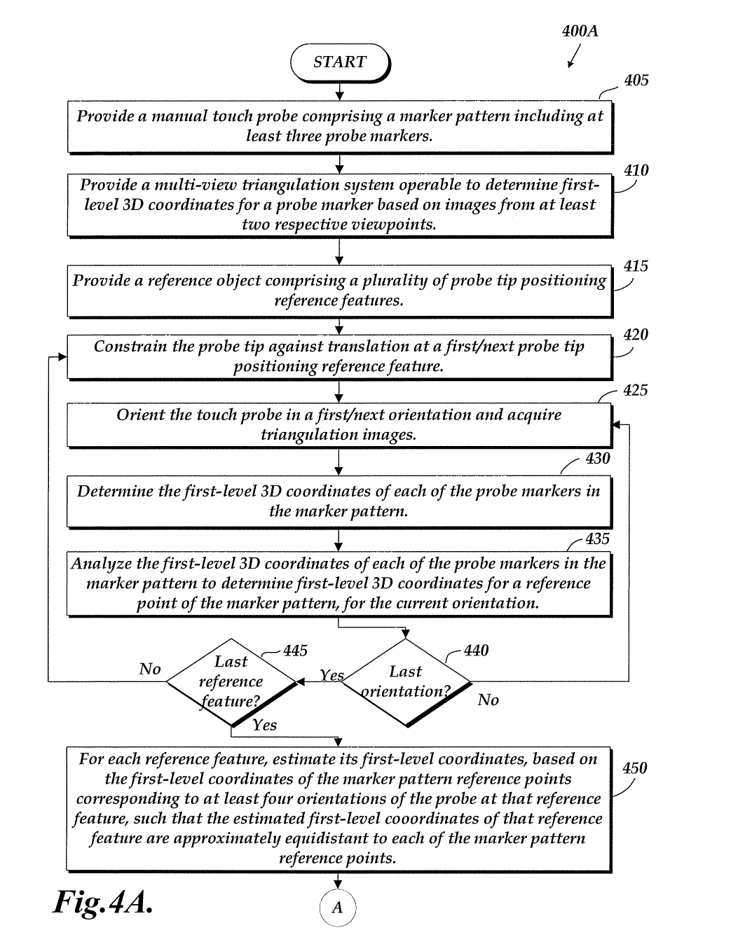

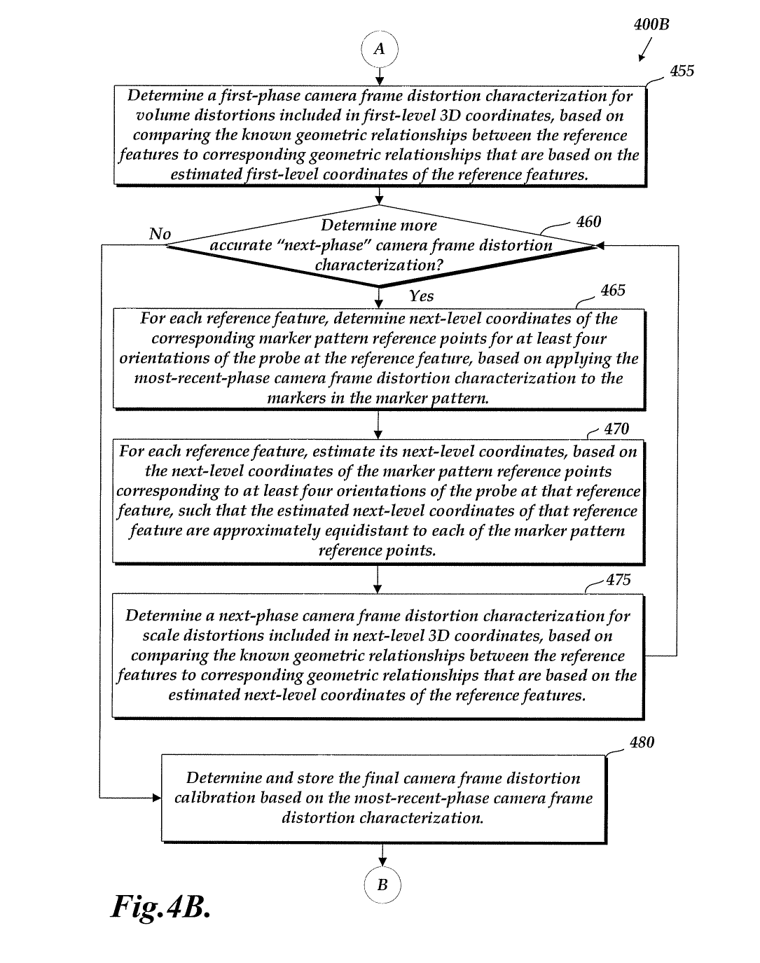

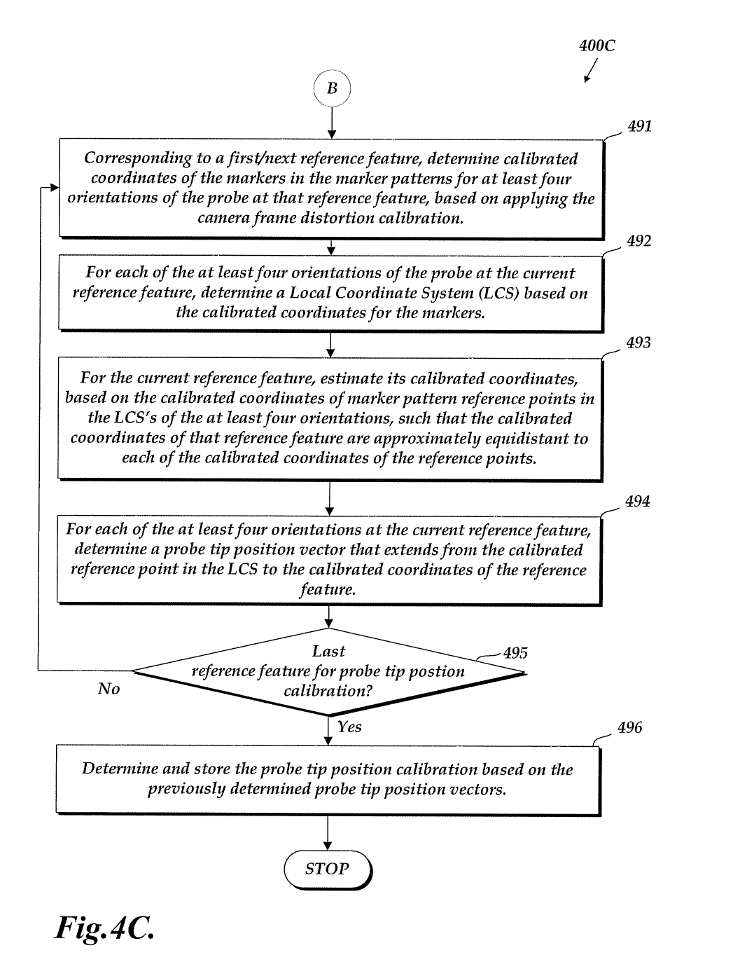

The relationships between the coordinates of the reference features RF1-RF4 on the portable calibration jig 160 are precisely known by independent measurement. As will be described in more detail below with reference to FIGS. 4A and 4B, during the global calibration of a multi-view vision-based touch probe system process the precisely known coordinate relationships of the reference features RF1-RF4 are compared to estimated measured locations determined using the vision-based touch probe system, and the differences are utilized for the calibration of camera frame distortion errors.

In alternate embodiments, a calibration jig may use different patterns or numbers of reference features that include mechanical or visual constraints, or the like. Generally, it is desirable for the reference features to include at least 4 features, at least one of which is non-coplanar with the others. In some embodiments, it is desirable to make their coordinates vary over a similar range in all three dimensions. As a specific example, in one embodiment a cubical configuration can be utilized with eight reference features (e.g. one at each corner of the cube). In general, increasing the number of calibration reference features may increase the reliability of the calibration, at the expense of increasing the calibration complexity and time.

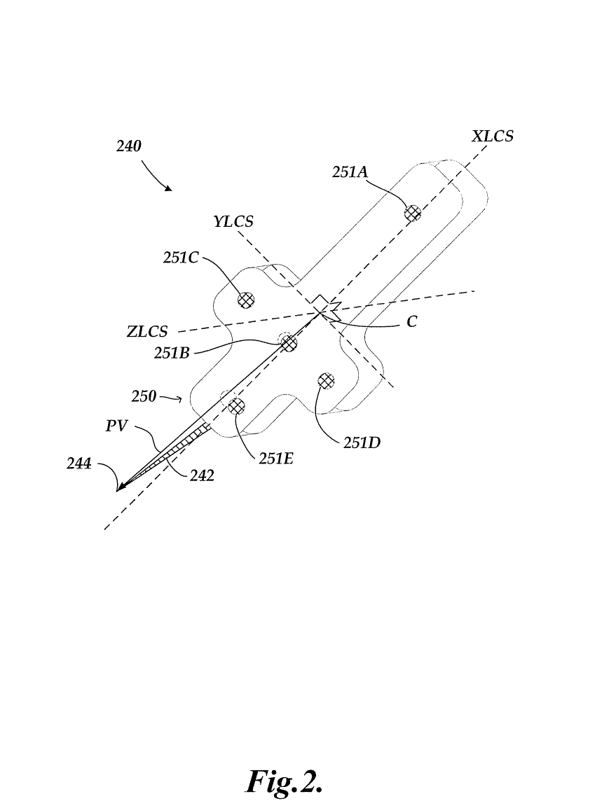

FIG. 2 is a diagram illustrating various features of a touch probe 240, including imperfections which may be addressed by probe tip position calibration. The probe 240 is similar to the probe 140 of FIG. 1, except as otherwise described below. As shown in FIG. 2, the probe 240 includes a marker pattern 250 and a stylus 242 with a probe tip 244. The marker pattern 250 includes five individual markers 251A-251E. One example of imperfections which may occur in the probe 240 includes one or more of the markers 251A-251E deviating from their nominal or ideal positions. For example, as shown in FIG. 2, the imperfectly manufactured probe 240 has markers 251B and 251E that deviate from their nominal positions (the nominal positions being indicated by dotted-line circles adjacent to the actual marker positions). Another imperfection may be that the probe tip 244 deviates from its nominal or ideal position. For example, as shown in FIG. 2, the stylus 242 and probe tip 244 are not aligned with the body of the probe 240. Preventing probe form imperfections such as those outlined above may not be cost-effective in low cost desktop systems, or the like. It may be more cost effective and/or accurate to use probe tip position calibration according to this invention, described further below, to determine the actual “imperfect” location of the probe tip 244 relative to a probe coordinate system that is adapted to the actual “imperfect” marker pattern 250.

FIG. 2 shows one example of local coordinate system (LCS) that can be adapted or fit to any actual “imperfect” marker pattern, such as the marker pattern 250. In particular, the orthogonal XLCS-YLCS-ZLCS axes shown in FIG. 2 may be established by applying the known mathematical technique of principal component analysis (PCA) to the three dimensional coordinates of any set of at least three markers. However, in general, better repeatability and/or accuracy may be obtained when more markers are used, and using more than five markers (e.g. 7 or 9 markers) on the probe 240 may be advantageous in various embodiments.

Generally speaking, for any set of at least two triangulation images corresponding to a measurement point, three dimensional coordinates may be established for each marker in the images by applying known triangulation techniques, as outlined above. Then, the LCS associated with the set of markers (and/or the touch probe) may be established by using PCA techniques as outlined further below, or the like. Once the LCS has been established, the actual location of the probe tip 244 relative to the marker pattern 250 may be characterized by a calibrated probe tip position vector PV that extends from the origin of the LCS to the location of the probe tip, as shown in FIG. 2. The application of these techniques in a global calibration method according to this invention is described in greater detail below.

Regarding PCA techniques, PCA is a known orthogonal linear transformation technique for reducing multidimensional data sets. Unlike many other linear transforms, including those conventionally used for probe calibration, PCA does not have a fixed set of basis vectors. Its basis vectors depend on the data set. Thus, it is well suited to characterizing an unpredictably distorted marker pattern. In the present case, the basis vectors are colinear with the orthogonal axes of a corresponding LCS. The steps of PCA generally comprise: calculate the empirical mean of each dimension (e.g. the x-coordinate mean, etc.), calculate the deviations from the mean for each dimension, and find a diagonalized covariance matrix based on the deviations for all three dimensions. The eignevectors of the diagonalized covariance matrix are the basis vectors, which are colinear with the orthogonal axes of the LCS.

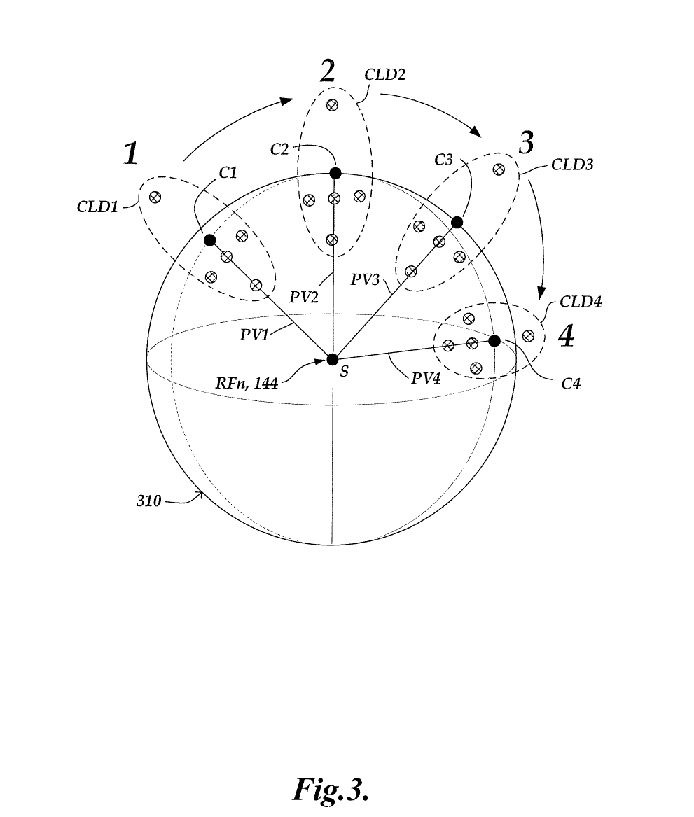

FIG. 3 is a schematic diagram illustrating various aspects of a global calibration process according to this invention, wherein the tip (e.g. the tip 144) of a touch probe (e.g. the touch probe 140) is constrained at a generic reference feature RFn (e.g. the reference feature RF4), while the body of the touch probe is rotated so that marker measurement images may be taken of the probe marker pattern with the touch probe in multiple orientations. FIG. 3 illustrates a measurement sequence in which the probe has been rotated through a series of four orientations, orientations 1-4. For each orientation, triangulation images are acquired. Then, for each orientation, the triangulation images are analyzed according to known methods to determine the apparent three dimensional coordinates of the markers in the world coordinate system, that is, the overall coordinate system of the touch probe measurement system. This results in a measured and stored “cloud” of marker positions CLD1 at orientation 1, a cloud CLD2 at orientation 2, etc. Next, in one embodiment, a technique such as PCA is applied to the data of each cloud, as outlined with reference to FIG. 2, to determine the world coordinates of the origin of a LCS associated with the cloud. The origin of each LCS may be taken as a marker pattern reference point (generically referred to as Cn) for the marker pattern at that orientation. Alternatively, if it is not useful to define the axes of the LCS during a particular phase or iteration within a global calibration method according to this invention, a marker pattern reference point that is approximately equivalent to the origin of the LCS may be found by a simpler mathematical procedure, for example the three-dimensional (3D) centroid of a marker pattern may be used as the marker pattern reference point in the initial phase of some embodiments of a global calibration method according to this invention.

Marker pattern reference points Cn are illustrated in FIG. 3 as marker pattern reference point C1 for cloud CLD1, marker pattern reference point C2 for cloud CLD2, etc. Ideally, for a rigid touch probe, the probe tip 144 should be at the same distance from each of the marker pattern reference points C1-C4. Therefore, a sphere 310 is fitted to the world coordinates of the marker pattern reference points C1-C4, according to known methods. For example, in one embodiment the sphere fitting may be expressed as a linear least squares problem and may be solved by standard linear methods (e.g. matrix pseudo-inverse).

In general, the center S of the fitted sphere 310 provides an estimate or measurement of the location of the probe tip 144 and the corresponding reference position RFn. However, it should be appreciated that during a first iteration of the portion of the global calibration process outlined above with reference to FIG. 3, camera frame distortion errors may generally introduce errors into the marker coordinate estimates/measurements and, therefore, into the resulting sphere fitting, and the resulting position estimates for the reference features RFn. Therefore, a global calibration process according to this invention initially repeats the process outlined above for a plurality of reference features (e.g. the reference features RF1-RF4, shown in FIG. 1), and determines a corresponding sphere center and estimated/measured location for each reference feature (e.g. RF1-RF4). An additional portion of the global calibration method then compares the geometric relationships between the estimated/measured locations of the reference features with the known geometric relationships of the reference features, in order to provide a camera frame distortion calibration (e.g. a set of camera frame distortion parameters) that approximately eliminates the camera frame distortion errors. In general, the camera frame distortion calibration will make the geometric relationships between the estimated/measured locations of the reference features in the world coordinate system approximately agree with the known geometric relationships of the reference features. A more complete description of this aspect of a global calibration process according to this invention is described in more detail below with reference to FIGS. 4A and 4B.

FIG. 3 also illustrates that the location of the sphere center S may be converted to a position in each LCS, defining the probe tip position vectors PV1-PV4 between each LCS origin and the sphere center S. In general, the position vectors PV1-PV4 may be analyzed (e.g. averaged, or replaced by a least squares fit) to provide a calibrated probe tip position vector PV, as previously outlined with reference to FIG. 2. However, it should be appreciated that early in a global calibration method according to this invention (prior to determining a useable camera frame distortion calibration), camera frame distortion errors may generally introduce errors into the marker coordinate estimates/measurements and, therefore, into the resulting sphere fitting and the associated estimates of the position vector PV and reference position RFn. Therefore, in various embodiments of a global calibration method according to this invention, an initial or subsequent camera frame distortion calibration is generally applied to remove camera frame distortion errors from the coordinates of the markers in the clouds (e.g. the clouds CD1-CD4) before determining the associated LCS's and position vectors (e.g. the position vectors PV1-PV4) and the resulting probe tip position calibration vector PV. A more complete description of this aspect of a global calibration process according to this invention is described in more detail below with reference to FIGS. 4A and 4B.

FIGS. 4A-4C are flow diagrams illustrating one exemplary routine 400 according to this invention for global calibration of a multi-view vision-based touch probe system. As shown in FIG. 4A, at a block 405 a manual touch probe (e.g. probe 140) is provided which comprises a marker pattern (e.g. marker pattern 150) including at least three probe markers (e.g. markers 151A, etc.) At a block 410, a multi-view triangulation system (e.g. stereo vision system 120) is provided which is operable to determine first-level three dimensional coordinates for a probe marker based on images from at least two respective views (e.g. cameras 130A and 130B). “First-level” coordinates means the determined coordinates that may include some level of camera frame distortion errors. At a block 415, a reference object (e.g. the portable calibration jig 160) is provided comprising a plurality of probe tip positioning reference features having known geometric relationships between the reference features (e.g. the reference features RFn.)

At a block 420, the probe tip (e.g. the probe tip 144) is constrained with respect to translation at a first/next reference feature. At a block 425, the touch probe is oriented in a first/next orientation and triangulation images are acquired. At a block 430, the first-level three dimensional coordinates are determined for each of the markers in the marker pattern (e.g. the cloud CLD1 of FIG. 3), based on the triangulation images. In the embodiment shown in FIGS. 4A and 4B, at a block 435, the first-level three dimensional coordinates are analyzed for each of the probe markers in the marker pattern to determine the first-level three dimensional coordinates for a marker pattern reference point for the current orientation (e.g. the reference point C1 of orientation 1 of FIG. 3). The analysis may comprise PCA or centroid calculations, or the like, as outlined above.

At a decision block 440, a determination is made as to whether the last orientation of the touch probe has been provided for the current reference feature. If the last orientation has not been reached, then the routine returns to the block 425. If the last orientation has been reached, then the routine continues to a decision block 445. In various embodiments, at least four orientations are provided for each reference feature. At decision block 445, a determination is made as to whether the current reference feature is the last reference feature to be used for calibration. If it is not the last reference feature, then the routine returns to block 420. If it is the last reference feature, then the routine continues to a block 450. In various embodiments, at least four reference features are provided.

At block 450, for each reference feature, its first-level coordinates are estimated, based on the first-level coordinates of the marker patterns corresponding to at least four orientations of the probe at that reference feature, such that the estimated first-level coordinates of that reference feature are approximately equidistant to each of the corresponding marker patterns. In one embodiment, the first-level coordinates of the reference feature are estimated by fitting a sphere to the corresponding first-level marker pattern reference points found by the operations of block 435 (e.g. the reference points C1-C4), and using the center of the sphere (e.g. the center S of the sphere 310) as the first-level coordinates of the reference feature. The routine then continues to a point A, which is continued in FIG. 4B.

As shown in FIG. 4B, from the point A the routine continues to a block 455. At block 455, a first-phase camera frame distortion characterization is determined for distortions included in the first-level three dimensional coordinates, based on comparing the known geometric relationships between the reference features to corresponding geometric relationships that are based on the estimated first-level coordinates of the reference features. Exemplary methods of determining the first-level camera frame distortion characterization is described in greater detail below. The routine then continues to a decision block 460, where it is decided whether a more accurate “next-phase” camera frame distortion characterization (e.g. a second- or third-phase characterization) is to be determined. In one embodiment, this decision is based on determining whether the comparison made in the operations of block 455, and/or the resulting first-phase camera frame distortion characterization, are indicative of significant camera frame distortion errors (e.g. coordinate errors above a predetermined threshold). If it is decided that a more accurate “next-phase” camera frame distortion characterization is required, then the operations of blocks 465, 470, and 475 are performed. Otherwise, the routine continues at block 480, as described further below.

To determine a more accurate “next-phase” camera frame distortion characterization, in the embodiment shown in FIG. 4B, at block 465, for each reference feature, next-level coordinates are determined for the marker pattern reference points corresponding to at least four orientations of the probe at that reference feature, based on applying the first-phase camera frame distortion characterization to the markers in the marker patterns. For example, in one embodiment, the locations of the reference points C1-C4 are recalculated based on next-level coordinates for the markers in the clouds CLD1-CLD4. “Next-level” coordinates means the coordinates are at least partially corrected for camera frame distortion errors, based on the first- or most-recent-phase camera frame distortion characterization. It will be appreciated that the first- or most-recent-phase distortion characterization may be applied to the 3D positions determined from the triangulation image data acquired by operations at the block 425. It is not necessary to acquire new triangulation images.

At block 470, for each reference feature, its next-level coordinates are estimated based on the next-level coordinates of the corresponding marker pattern reference points determined in the operations of block 465, such that the estimated next-level coordinates of that reference feature are approximately equidistant to the next-level coordinates of each of the marker pattern reference points. Operations at block 470 may be analogous to the those outlined above for block 450.

At block 475, a next-phase camera frame distortion characterization is determined for scale distortions included in next-level 3D coordinates, based on comparing the known geometric relationships between the reference features to corresponding geometric relationships that are based on the estimated next-level coordinates of the reference features. Exemplary methods of determining the next-level camera frame distortion characterization may be analogous to those used for the operations of block 450, and are described in greater detail below. The routine then returns to the decision block 460.

If it is decided at decision block 460 that a more accurate “next-phase” camera frame distortion characterization is not required, then the routine jumps to block 480, where the final camera frame distortion calibration is determined and stored, based on the most-recent-phase camera frame distortion characterization (e.g. the first- or second-phase characterization, etc.). In various embodiments, the final camera frame distortion calibration may take a form identical to the most-recent-phase camera frame distortion characterization (e.g. an identical set of parameters). However, in various other embodiments, the final camera frame distortion calibration may take the form of a look-up table, or some other form derived from most-recent-phase camera frame distortion characterization. The routine then continues to a point B, which is continued in FIG. 4C.

FIG. 4C includes a portion of the global calibration routine 400 that determines the final probe tip position calibration that is used to correct probe form errors. As shown in FIG. 4C, from the point B the routine continues to a block 491. At block 491, corresponding to a first/next one of the reference features, calibrated coordinates of the markers in the marker patterns are determined for at least four orientations of the probe at that reference feature, based on applying the camera frame distortion calibration. “Calibrated coordinates” means the coordinates are corrected for camera frame distortion errors, based on the final camera frame distortion calibration (or based on the most-recent-phase camera frame distortion characterization, which may provide approximately the same coordinate accuracy).

At a block 492, for each of the at least four orientations of the probe at the reference feature of block 491 (the current reference feature), a Local Coordinate System (LCS) is determined based on the calibrated coordinates for the markers. In one embodiment, the LCS may be established by PCA, as described above with reference to FIG. 2.

At a block 493, for the current reference feature, its calibrated coordinates are estimated based on the calibrated coordinates of marker pattern reference points in the LCS's determined for at least four orientations in the operations of block 492, such that the calibrated coordinates of the current reference feature are approximately equidistant to each of the calibrated coordinates of the reference points. In one embodiment, the reference point in each LCS is the LCS origin. However, another reference point may be used in other embodiments, provided that it has the same coordinates in each LCS.

At a block 494, for each of the at least four orientations at the current reference feature, a probe tip position vector is determined that extends from the calibrated reference point in the LCS to the calibrated coordinates of the reference feature estimated in the operations of block 493 (e.g. vectors analogous to the vectors PV1-PV4 in FIG. 3 are determined). The routine then continues to a decision block 495, where a determination is made as to whether the current reference feature is the last reference feature to be analyzed for the probe tip position calibration. In one embodiment, this decision may be based on comparing the probe tip position vectors determined in the operations of block 494, and determining whether their corresponding tip positions vary by a significant amount from one another, either in a statistical sense or in terms of the distance between their tip locations. In other embodiments, it may simply be decided to use all available reference positions. In any case, if the current reference feature is not the last reference feature to be used for the probe tip position calibration, then the routine returns to block 491. Otherwise, the routine continues to a block 496.

At block 496, the probe tip position calibration is determined and stored based on the previously determined probe tip position vectors, and the routine ends. In one embodiment, the previously determined probe tip position vectors (e.g. vectors analogous to PV1-PV4 in FIG. 3) may be averaged to provide a probe tip position calibration vector (e.g. a vector analogous to the vector PV in FIG. 2). However, in various embodiments, it may be more accurate to determine a probe tip position calibration vector by a more sophisticated method such as a weighted mean, robust averaging (including outlier detection), geometric or arithmetic-geometric means, clustering approaches or other statistical, geometric or heuristic methods, based on the previously determined probe tip position vectors.

As noted above, the routine 400 of FIGS. 4A and 4B performs global calibration for a multi-view vision-based touch probe system. To summarize, roughly speaking, the operations of blocks 405-445 provide image data used throughout the calibration routine; the operations of blocks 405-480 provide camera frame distortion calibration; and the operations of blocks 491-496 provide probe tip position calibration. It should be appreciated that in the routine 400, the camera frame distortion calibration (e.g. the results of the operations of blocks 405-480) comprises an iterative calibration process that depends on the use of a touch probe with a tip. Nevertheless, it is independent of any probe form distortion errors, and uses a set of calibration images wherein the only relevant features in the images are the markers on the touch probe. Furthermore, the probe tip position calibration operations (e.g. the operations of blocks 491-496) depend on the results of the camera frame distortion calibration, and also use a set of calibration images wherein the only relevant features in the images are the markers on the touch probe. When the same probe tip is used throughout the entire global calibration procedure, particular efficiency results from the fact that the images used by the probe tip position calibration operations are from the same set of images used by the camera frame distortion calibration operations. Various other aspects of the routine 400 will be described in more detail below with reference to the relevant blocks.

With regard to the blocks 450 and/or 470, as noted above, in one embodiment their operations may include, for each reference feature, fitting a sphere (e.g. sphere 310) to reference points of the clouds of marker coordinates (e.g. the reference points C1-C4 of the marker clouds CLD1-CLD4, as determined by PCA, or centroid calculation, or the like). The center of each such sphere provides an estimate of the location of the corresponding reference feature, which coincides with the actual location of the constrained probe tip. However, in other embodiments according to this invention, a sphere may be fit to the locations of a particular marker (e.g. marker 151A) in each of the marker clouds. In essence, that particular marker then becomes the “reference point” for the marker cloud. In general, this will provide a less accurate estimate of the reference feature (and probe tip) location than “statistically determined” reference points (e.g. the reference points C1-C4 as determined by PCA or centroid calculations). However, if a separate sphere is fit to each of the individual markers in the marker pattern, and if an average or other meaningful statistical or geometric representation of the centers of those spheres is then used as the estimate of the reference feature (and probe tip) location, then similar accuracy may be achieved.

As will be described in more detail below, in one embodiment, in order to characterize camera frame distortion errors, three scaling coefficients are applied to the three axes of the world coordinate system. The world coordinate system may be defined by stereo calibration of the two cameras 130A and 130B. One basic assumption of this process is that the three-dimensional position measurements obtained by the stereo vision system contain errors that can be modeled by the scaling coefficients applied to each axis of the world coordinate system.

With regard to the blocks 455 and/or 475, as noted above, in various embodiments their operations may include determining a first- or next-phase camera frame distortion characterization for scale distortions included in first- or next-level 3D coordinates, based on comparing the known geometric relationships between the reference features to corresponding geometric relationships that are based on the estimated next-level coordinates of the reference features. In one embodiment, the end result of a camera frame distortion characterization is a set of scaling parameters that characterize and/or compensate for camera frame distortion errors in the system's measurement volume, such that estimated/measured locations are as close as possible to the “true” locations. A portable calibration jig (e.g. the jig 160) provides the “true” reference dimensions or relationships that govern determination of the camera frame distortion characterization and/or scaling parameters. Some examples of equations for finding an exemplary set of scaling coefficients are described below. In the equations the “current-level” coordinates of the centers of the fitted spheres at each of four reference features RF1-RF4 are designated as (x1, y1, z1), (x2, y2, z2), (x3, y3, z3) and (x4, y4, z4) respectively. Furthermore, the known “true” distances d1-d6 between the reference features RF1-RF4 are defined as follows: d1=RF1 to RF2, d2=RF2 to RF3, d3=RF1 to RF3, d4=RF1 to RF4, d5=RF2 to RF4 and d6=RF3 to RF4. It will be appreciated that the following equations are directed to a portable calibration jig with four reference features. However an analogous method may be applied using a portable calibration jig with a larger number of reference features, with the only change being a larger number of constraint equations (i.e. known distances between the various reference features).

The following equations are directed toward an embodiment that finds three scaling coefficients (a, b, c), one linear scaling coefficient of scale factor for each axis of the world coordinate system, that make the distances between the estimated reference feature coordinates as close as possible to the “true” distances between the reference features RF1-RF4 in the portable calibration jig 160. For example, for the distance d1, it is desired to fulfill the equality:

\sqrt{(ax2−ax1)²+(by2−by1)²+(cz2−cz1)²}=d1 (Eq. 1)

After squaring and rearranging EQUATION 1:

a²(x2−x1)²+b²(y2−y1)²+c²(z²−z1)²=d1² (Eq. 2)

Similar equations can be formulated for all six distances d1-d6 and expressed in the following matrix form:

$$[ \begin{matrix}{( x2 - x1 )}^{2} & {( y2 - y1 )}^{2} & {( z2 - z1 )}^{2} \\ {( x3 - x2 )}^{2} & {( y3 - y2 )}^{2} & {( z3 - z2 )}^{2} \\ {( x1 - x3 )}^{2} & {( y1 - y3 )}^{2} & {( z1 - z3 )}^{2} \\ {( x4 - x1 )}^{2} & {( y4 - y1 )}^{2} & {( z4 - z1 )}^{2} \\ {( x4 - x2 )}^{2} & {( y4 - y2 )}^{2} & {( z4 - z2 )}^{2} \\ {( x4 - x3 )}^{2} & {( y4 - y3 )}^{2} & {( z4 - z3 )}^{2}\end{matrix} ] \cdot [ \begin{matrix}{a}^{2} \\ {b}^{2} \\ {c}^{2}\end{matrix} ] = [ \begin{matrix}{d1}^{2} \\ {d2}^{2} \\ {d3}^{2} \\ {d4}^{2} \\ {d5}^{2} \\ {d6}^{2}\end{matrix} ] \qquad \text{(Eq. 3)}$$

The above is an over-determined system of linear equations in the unknowns [a², b², c²]^{T} which can be solved using standard methods (e.g. matrix pseudo-inverse, singular value decomposition), producing a least-squares solution for the scaling coefficients (a, b, c).

It will be appreciated that not all six equations are needed to solve for the three parameters [a², b², c²]^{T}; and in one embodiment four equations are sufficient. Therefore, some of the known distances in the portable calibration jig 160 can be ignored as long as all of the coordinates of the reference features RF1-RF4 that are used are present on the left side of the matrix equation. However, using more constraints (more known distances) will, in some implementations, make the calibration results more robust and accurate due to the “averaging” of potential measurement errors or inaccuracies.

It will be appreciated that according to the principles of this invention, it is not necessary to align the portable calibration jig with respect to the world coordinate system. In general, it can be placed anywhere in the system's measurement volume, although locating the reference features to span most or all of the measurement volume may be advantageous in various embodiments.

In other embodiments, more complex camera frame distortion errors may be modeled and corrected using scaling parameters based on a non-linear error model. The following equations are directed toward an embodiment that finds 21 “nonlinear” scaling parameters, using a portable calibration jig that includes a sufficient number of suitably arranged reference features. In particular, the associated model assumes non-linear distortions along the x, y and z axes, according to EQUATION 4:

x″=x′+ax′²+bx′y′+cx′y′²+dx′z′+ex′z′²+fy′+gz′+X_{C}

y″=y′hy′²+iy′x′+jy′x′²+ky′z′+ly′z′²+mx′+nz′+Y_{C}

z″=z′+oz′²+pz′x′+qz′x′²+rz′y′+sz′y′²+tx′+uy′+Z_{C} (Eq. 4)

where x″, y″ and z″ are corrected (undistorted) coordinates in the world coordinate system, (X_{C}, Y_{C}, Z_{C}) are the “current-level” coordinates of a reference point on the portable calibration jig (e.g. one of the reference features) as estimated/measured in the world coordinate system during calibration, and x′, y′ and z′ are “current-level” coordinates estimated/measured in the world coordinate system relative to the selected reference point on the portable calibration jig. Thus:

x′=x−X_{C}

y′=y−Y_{C}

z′=z−Z_{C} (Eq. 5)

One example of a suitable portable calibration jig that can be used for determining the 21 scaling parameters a-u includes nine or more non-colinear reference features distributed approximately in a plane that may be registered at a known angle with respect to the horizontal plane of the world coordinate system. Similar to the three-parameter case, based on the equations outlined above and a corresponding portable calibration jig having a sufficient number of suitably arranged reference features (e.g. the nine reference feature jig outlined above), it is possible to set up a system of linear equations to find the non-linear scaling parameters a-u according to known methods. In contrast to the three-parameter case described earlier, to allow applying linear least squares method to each world coordinate system axis separately, a “jig coordinate system” used to record the known reference feature coordinates for the nine reference feature jig has to be appropriately registered relative to the world coordinate system. The registration may be achieved via physical registration, or through preliminary triangulation measurements to determine appropriate coordinate transformations, or by a combination of the two.

Other known modeling methods and solutions are also usable for characterizing camera frame distortion errors according to this invention. It will be appreciated that the camera frame distortion error models and scaling parameter solutions outlined above are exemplary only and not limiting. It will also be appreciated that linear or lower-order non-linear models are more applicable when complex non-linear optical distortions due to the individual camera systems are not present in the triangulation images. Therefore, in some embodiments, either the individual camera systems are selected to be sufficiently free of optical aberrations, or image distortions in the individual camera systems are separately calibrated according to known methods, and the data of the triangulation images is then adjusted for individual image distortions according to known methods, prior to being used for the triangulation calculations included a global calibration method according to this invention.

With regard to the operations of block 465, in various embodiments the most robust and accurate calibration results are obtained by determining the next-level coordinates for the marker pattern reference points, based on applying the most-recent-phase camera frame distortion characterization to all the markers in the marker patterns, and determining the next-level coordinates for the reference points using PCA or centroid calculations, or the like, as previously outlined. However, when the camera frame distortion errors are not too severe or nonlinear, then it may be sufficient to directly adjust the previously determined coordinates of the marker pattern reference points themselves, based on the most-recent-phase camera frame distortion characterization. In this case, the method bypasses or eliminates the operations of adjusting the individual marker coordinates and repeating the calculations used to determine the previous reference point coordinates (e.g. PCA or centroid calculations, or the like).

In a test of an actual embodiment comprising a calibration jig similar to the portable calibration jig 160, and a routine similar to the routine 400 that determined linear scaling parameters similar to those outlined with reference to EQUATIONS 1-3, the method converged to provide accurate and stable global calibration results after approximately 10 iterations of operations corresponding to the blocks 460-475.

It will be appreciated that in an alternate embodiment, global calibration may be interrupted after the camera frame distortion calibration (e.g. the operations of blocks 405-480). Different probe tips may be utilized for different calibration functions. For example, a first probe tip may be used for the camera frame distortion calibration (e.g. the operations of blocks 405-480), and a second (different) probe tip which will be used for performing actual measurements may be installed in the touch probe body for performing the probe tip position calibration (e.g. the operations of blocks 491-496). However, in such a case, additional calibration images must be acquired in at least four orientations while the second probe tip is constrained against translation, and these additional calibration images must be used in the probe tip position calibration operations (e.g. in the operations of blocks 491-496). It will be appreciated that in this case, the camera frame distortion calibration depends on the use of the touch probe with the first tip, and is an iterative calibration process that is independent of any probe form distortion errors, and uses a set of calibration images wherein the only required features in the images are the markers on the touch probe. Furthermore, the second probe tip position calibration operations depend on the results of the camera frame distortion calibration (e.g. the results of the operations of blocks 405-480), and also use a set of calibration images wherein the only required features in the images are the markers on the touch probe. Thus, certain advantages of a global calibration method according to this invention are retained, even though additional images are required for the probe tip position calibration of the second probe tip.

While the preferred embodiment of the invention has been illustrated and described, numerous variations in the illustrated and described arrangements of features and sequences of operations will be apparent to one skilled in the art based on this disclosure. Thus, it will be appreciated that various changes can be made therein without departing from the spirit and scope of the invention.

1. A method for calibrating a multi-view vision-based touch probe system, the method comprising:
(A) providing a manual touch probe comprising a marker pattern including at least three probe markers and a probe tip that is fixed relative to the marker pattern;
(B) providing a multi-view triangulation system comprising at least two imaging viewpoints having intersecting fields of view, each viewpoint having a camera operable to provide an image of a probe marker located in the intersecting fields of view and the triangulation system operable to determine first-level 3D coordinates for the probe marker based on at least two respective images from at least two respective viewpoints;
(C) providing a reference object comprising a plurality of probe tip positioning reference features, wherein each probe tip positioning reference feature has at least one of a known geometric relationship and a known coordinate relationship in relation to other probe tip positioning reference features;
(D) estimating first-level 3D coordinates for each of a selected plurality of probe tip positioning reference features, the estimating comprising for each selected probe tip positioning reference feature:
(D-1) constraining the probe tip against translation at that probe tip positioning reference feature, and providing at least four orientations of the manual touch probe and the marker pattern, and for each of the at least four of the orientations:
(D-1-i) determining first-level 3D coordinates of each of the probe markers in the marker pattern for that orientation, and
(D-1 -ii) analyzing the first-level 3D coordinates of each of the probe markers in the marker pattern to determine first-level 3D coordinates for a marker pattern reference point of the marker pattern for that orientation,
(D-2) estimating the first-level 3D coordinates for that probe tip positioning reference feature based on the first-level 3D coordinates of at least four marker pattern reference points corresponding to the at least four orientations, such that the first-level 3D coordinate position of the probe tip positioning reference feature is estimated to be approximately equidistant to each of the first-level 3D coordinate positions of the at least four marker pattern reference points;
(E) determining a first-phase camera frame distortion characterization for distortions included in first-level 3D coordinates, based on comparing at least one of the known geometric relationships and the known coordinate relationships between the selected probe tip positioning reference features to corresponding relationships that are based on the estimated first-level 3D coordinates of the selected probe tip positioning reference features; and
performing operations comprising at least one of (F) and (G), wherein:
(F) comprises:
applying the first phase camera frame distortion characterization to estimate improved 3D coordinates for at least some of the selected probe tip positioning reference features, and determining a next-phase camera frame distortion characterization, based on comparing at least one of the known geometric relationships and the known coordinate relationships between the at least some of the selected probe tip positioning reference features to corresponding relationships that are based on the estimate improved 3D coordinates of the at least some of the probe tip positioning reference features, and
(G) comprises:
(G-1) corresponding to a selected probe tip positioning reference feature, applying one of the first-phase camera frame distortion characterization and a next-phase camera frame distortion characterization, to determine calibrated 3D coordinates of the probe markers in the marker patterns for at least four orientations of the manual touch probe and the marker pattern at that selected probe tip positioning reference feature;
(G-2) for each of the at least four orientations of the manual touch probe and the marker pattern in (G-1), determining a respective local coordinate system (LCS) based on the calibrated 3D coordinates of the probe markers in the marker pattern for that respective orientation;
(G-3) estimating calibrated 3D coordinates for the selected probe tip positioning reference feature of (G-1), based on calibrated 3D coordinates for respective marker pattern reference points identified in each of the respective LCSs determined in (G-2), such that the calibrated 3D coordinates for the selected probe tip positioning reference feature are approximately equidistant to the calibrated 3D coordinates of the respective marker pattern reference points;
(G-4) determining a plurality of respective probe tip position vectors in terms of the respective LCSs determined in (G-2), each respective probe tip position vector extending from a respective marker pattern reference points identified in a respective LCS to the location of the calibrated 3D coordinates for the selected probe tip positioning reference feature as expressed in terms of that respective LCS; and
(G-5) determining a probe tip position calibration based at least partially on the plurality of respective probe tip position vectors determined in (G-4).

2. A method for calibrating a multi-view vision-based touch probe system, the method comprising:
(A) providing a manual touch probe comprising a marker pattern including at least three probe markers and a probe tip that is fixed relative to the marker pattern;
(B) providing a multi-view triangulation system comprising at least two imaging viewpoints having intersecting fields of view, each viewpoint having a camera operable to provide an image of a probe marker located in the intersecting fields of view and the triangulation system operable to determine first-level 3D coordinates for the probe marker based on at least two respective images from at least two respective viewpoints;
(C) providing a reference object comprising a plurality of probe tip positioning reference features, wherein each probe tip positioning reference feature has at least one of a known geometric relationship and a known coordinate relationship in relation to other probe tip positioning reference features and is configured such that when the probe tip is constrained against translation at that reference feature an effective location of the center of the probe tip is the same for a plurality of angular orientations of the touch probe relative to the reference object;
(D) estimating first-level 3-D coordinates for each of a selected plurality of the probe tip positioning reference features, the estimating comprising for each selected probe tip positioning reference feature:
(D-1) constraining the probe tip against translation at that probe tip positioning reference feature and providing a plurality of orientations relative to the reference object, and for each of at least four of the orientations:
(D-1-i) determining the first-level 3D coordinates of each of the probe markers in the marker pattern for that orientation, and
(D-1-ii) analyzing the first-level 3D coordinates of each of the probe markers in the marker pattern to determine first-level 3D coordinates for a marker pattern reference point of the marker pattern for that orientation,
(D-2) estimating the first-level 3-D coordinate location for that probe tip positioning reference feature based on the first-level 3D coordinates of the marker pattern reference points corresponding to the at least four orientations, such that the first-level 3-D coordinate location for that probe tip positioning reference feature is estimated to be approximately equidistant to each of those marker pattern reference points as indicated by their first-level 3D coordinates;
(E) determining a first-phase camera frame distortion characterization for distortions included in first-level 3D coordinates, based on comparing at least one of the known geometric relationships and the known coordinate relationships of at least some of the selected plurality of the probe tip positioning reference features to corresponding relationships that are based on the estimated first-level 3D coordinates of the at least some of the selected plurality of probe tip positioning reference features; and
(F) estimating improved 3-D coordinates for at least one probe tip positioning reference feature, the estimating comprising for each at least one probe tip positioning reference feature:
(F1) applying the first-phase camera frame distortion characterization to determine improved 3D coordinates for a marker pattern reference point of a marker pattern associated with that probe tip positioning reference feature for at least four orientations of the manual touch probe and the marker pattern at that selected probe tip positioning reference feature, the at least four orientations provided while the probe tip is constrained against translation at that probe tip positioning reference feature; and
(F-2) estimating the improved 3-D coordinates for that probe tip positioning reference feature based on the improved 3D coordinates for the marker pattern reference points of the marker patterns for the at least four orientations, such that the 3-D coordinate location for that probe tip positioning reference feature is estimated to be approximately equidistant to each of those marker pattern reference points as indicated by their improved 3D coordinates.

3. The method of claim 2, further comprising:
(G) determining, for each of a plurality of the marker patterns of step (F-i), next-level 3D coordinates for each of their probe markers, and defining a marker pattern frame of reference for each of those marker patterns based on the next-level 3D coordinates for each of their probe markers; and
(H) determining, for each of the plurality of marker patterns having defined frames of reference in step (G), a probe tip position vector that extends from a marker pattern reference point in the defined frame of reference of that marker pattern to the improved 3-D coordinates of the nearest probe tip positioning reference feature if it has improved 3-D coordinates, and determining a probe tip position calibration based at least partially on a plurality of the probe tip position vectors.

4. The method of claim 3, wherein in step (G) the next-level 3D coordinates for the probe markers are determined based on applying the first-level distortion characterization to adjust and replace the first-level 3D coordinates of each of the probe markers in the marker pattern.

5. The method of claim 2, wherein in step (F-1) determining improved 3D coordinates for the marker pattern reference point of the marker pattern comprises, for each of the orientations:
determining next-level 3D coordinates for each of the probe markers in the associated marker pattern, based on applying the first-level distortion characterization to adjust and replace the first-level 3D coordinates of each of the probe markers in that marker pattern, and
determining the improved marker pattern reference point corresponding to the associated marker pattern, based on the next-level 3D coordinates for each of the probe markers for that marker pattern.

6. The method of claim 2, wherein the plurality of probe tip positioning reference features comprises at least four reference features.

7. The method of claim 2, wherein at least part of the method is iterated a plurality of times to improve the accuracy.

8. The method of claim 7, wherein the part of the method that is iterated a plurality of times includes at least step (B), wherein the first-phase camera frame distortion characterization becomes a next phase camera frame distortion characterization that is based on estimated next-level 3D coordinates of the at least some of the selected plurality of probe tip positioning reference features.

9. The method of claim 7, wherein the plurality of iterations are ceased when a selected criteria is reached.

10. The method of claim 9, wherein the selected criteria comprises one or more of: a specified maximum number of iterations being reached, an error value being reached that is smaller than a selected threshold, or the selected computed estimated locations no longer changing above a selected threshold amount within a selected number of additional iterations.

11. The method of claim 2, wherein in step (D-1 -ii) the first-level marker pattern reference point of the marker pattern comprises a calculated centroid of the marker pattern.

12. The method of claim 11, wherein step (D-2) comprises fitting a sphere to the centroids of the marker patterns, and the center of the sphere determines the first-level 3-D coordinate location for that probe tip positioning reference feature.

13. The method of claim 2, further comprising determining one or more next-level camera frame distortion characterizations in addition to the first-level camera frame distortion characterization.

14. The method of claim 2, wherein the plurality of probe tip positioning reference feature on the reference object have 3-D coordinate locations which vary over approximately equal ranges in all three dimensions.

15. The method of claim 2, wherein the reference object further comprises markers which are separate from the markers on the probe and which may be utilized as part of the distortion calibration process.

16. The method of claim 3, wherein the probe tip is removable and when a new probe tip is attached to the probe at least the steps G and H are repeated to determine a new probe tip position calibration for that new probe tip.

17. A calibration device for use with a machine vision system, the vision system generally including a manual touch probe comprising a marker pattern and a probe tip that is fixed relative to the marker pattern, the vision system being operable to determine first-level three dimensional coordinates for the marker pattern, the calibration device comprising:
a reference object comprising a plurality of probe tip positioning reference feature configured such that for each probe tip positioning reference feature a location for an effective center of the probe tip is the same for a plurality of angular orientations of the touch probe relative to the reference object when the probe tip is constrained against translation in the reference feature and that effective center is defined a location of that probe tip positioning reference feature, arid the locations of the probe tip positioning reference features on the reference object relative to one another are known.

18. The device of claim 17, wherein the reference object is usable in combination with the machine vision system for calibration by:
(A) estimating a first-level reference feature location for each of a plurality of the probe tip positioning reference feature s on the reference object; and
(B) determining a first-phase camera frame distortion characterization of scale distortions included in the first- phase estimated reference feature locations, the first-phase camera frame distortion characterization determined based on comparing a configuration of known locations of at least some of the reference features to a corresponding configuration of the first-level reference feature locations.

19. The device of claim 17, wherein the reference object further comprises its own markers which are detectable by the machine vision system such that their first-level 3-D coordinates may be established and used for camera frame distortion calibration.
